(19) United States
(12) Patent Application Publication
(10) Pub. No.: US 2008/0192166 A1
(43) Pub. Date: Aug. 14, 2008

(54) LIQUID CRYSTAL DISPLAY APPARATUS

(75) Inventors: SHIH-FANG WONG, Tu-Cheng (TW); TSUNG-JEN CHUANG, Tu-Cheng (TW); LEI-TONG YU, Shenzhen (CN); WEN-WU WANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/858,914

(22) Filed: Sep. 21, 2007

(30) Foreign Application Priority Data
Feb. 13, 2007 (CN) 200710200206.9

(51) Int. Cl. G02F 1/1333

(52) U.S. Cl. 349/58

(57) ABSTRACT

A liquid crystal display apparatus includes a display panel, a sensor, and a display control unit. The display panel is rotatable. The display panel includes a display unit for displaying data images. The sensor is for sensing a rotation of the display panel, and generating an analog signal including rotation direction information and rotation angle information. The display control unit is for controlling displaying orientation, brightness, and display ratio of the data images based on the rotation direction information and the rotation angle information.

### BACKGROUND OF THE INVENTION

1. Field of the Invention

The present invention generally relates to a liquid crystal display apparatus, and more particularly to a liquid crystal display apparatus having an adjustable aspect ratio.

2. Description of Related Art

Applications of liquid crystal displays (LCDs) to television sets, laptops, personal computers, and portable electronic devices have been rapidly developed in recent years. The LCDs have many characteristics, such as, viewing angle, resolution, and aspect ratio. The aspect ratio is defined as a width of an LCD divided by its height. The LCD has various aspect ratio standards, such as 4:3, 5:4, 16:9, and so on.

In practice, users often want to see images in different aspect ratios in an LCD. Take an LCD with a 16:9 aspect ratio as an example, when users watch movie, they want to see images in 16:9 aspect ratio, but when users browse through internet, they want to see images in 9:16 aspect ratio to facilitate scrolling web page. Therefore, a rotatable LCD is used to rotate its display panel to display images in two aspect ratios.

Referring to FIGS. 6A, 6B, and 6C, a rotatable LCD 10 includes a display panel 12, a stand 14, and a rotatable portion 16. The display panel 12 is connected to the stand 14 using the rotatable portion 16. The display panel 12 can be rotated by 90 degree. Therefore, users can press a control button (not shown) on the display panel 12 to change aspect ratio of images displayed in the display panel 12. However, it is convenient for users to change the aspect ratio manually.

Therefore, an LCD is needed in the industry to address the aforementioned deficiency.

### SUMMARY OF THE INVENTION

A liquid crystal display apparatus includes a display panel, a sensor, and a display control unit. The display panel is rotatable. The display panel includes a display unit for displaying data images. The sensor is for sensing a rotation of the display panel, and generating an analog signal including rotation direction information and rotation angle information. The display control unit is for controlling displaying orientation, brightness, and display ratio of the data images based on the rotation direction information and the rotation angle information.

Other systems, methods, features, and advantages of the present liquid crystal display apparatus will be or become apparent to one with skill in the art upon examination of the following drawings and detailed description. It is intended that all such systems, methods, features, and advantages should be included within this description, be within the scope of the present device, and be protected by the accompanying claims.

### BRIEF DESCRIPTION OF THE DRAWINGS

Many aspects of the present liquid crystal display apparatus can be better understood with reference to following drawings. Components in the drawings are not necessarily to scale, emphasis instead being placed upon clearly illustrating the principles of the present device. Moreover, in the drawings, like reference numerals designate corresponding parts throughout the several views.

FIG. 1 is a disassembled diagram showing a liquid crystal display apparatus in accordance with a first exemplary embodiment.

FIG. 2 is a schematic diagram showing a control system of the liquid crystal display apparatus of FIG. 1.

FIG. 3 is a schematic diagram showing a sensor of the liquid crystal display apparatus of FIG. 1.

FIG. 4 is a disassembled diagram showing a liquid crystal display apparatus in accordance with a second exemplary embodiment.

FIG. 5 is a schematic diagram showing a sensor of the liquid crystal display apparatus of FIG. 4.

FIG. 6A is a schematic front elevation diagram showing a conventional liquid crystal display apparatus with a first aspect ratio.

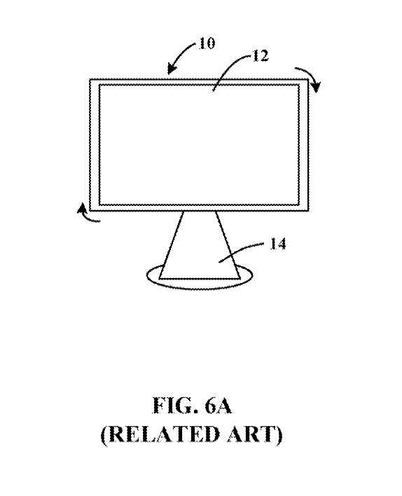

FIG. 6B is a schematic front elevation diagram showing the conventional liquid crystal display apparatus of FIG. 6A with a second aspect ratio.

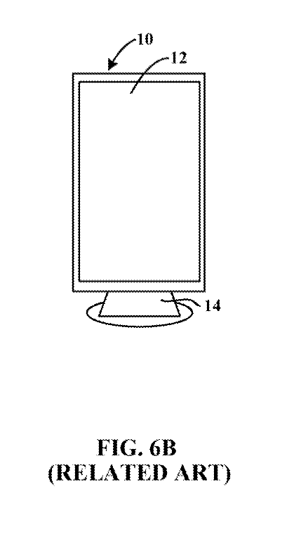

FIG. 6C is a schematic diagram showing the conventional liquid crystal display apparatus of FIG. 6A, but viewed from a rear aspect.

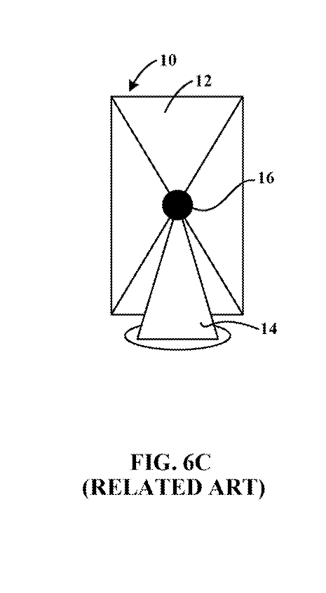

### DETAILED DESCRIPTION OF THE INVENTION

Reference will now be made to the drawings to describe a preferred embodiment of the present LCD.

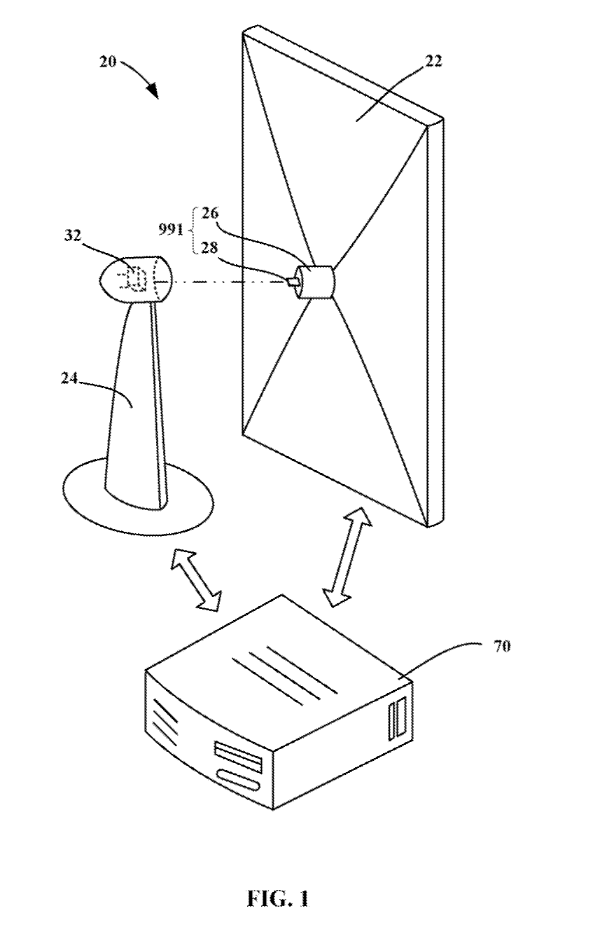

Referring to FIG. 1, an LCD 20 for displaying information received from a computer 70 in accordance with a first exemplary embodiment includes a display panel 22, a stand 24, a connection portion 26, an adjustable portion 28, and a sensor 32. The display panel 22 is connected to the stand 24 via the connection portion 26. In the embodiment, the display panel 22 and the stand 24 communicate with the computer 70 by wireless. In another embodiment, the display panel 22 and the stand 24 can be electrically connected to the computer 70.

The stand 24 is for supporting the display panel 22. The connection portion 26 is substantially columnar in shape and is formed on a centre of the display panel 22. The connection portion 26 is rotatable with respect to the stand 24. The adjustable portion 28 is formed on the connection portion 26 to be rotated with the connection portion 26. The sensor 32 is set in the stand 24 for sensing the rotation of the adjustable portion 28 and generating an electrical signal. The electrical signal is used for controlling aspect ratios of data images displayed in the display panel 22. The connection portion 26 and the adjustable portion 28 can be considered to be an adjusting element 991.

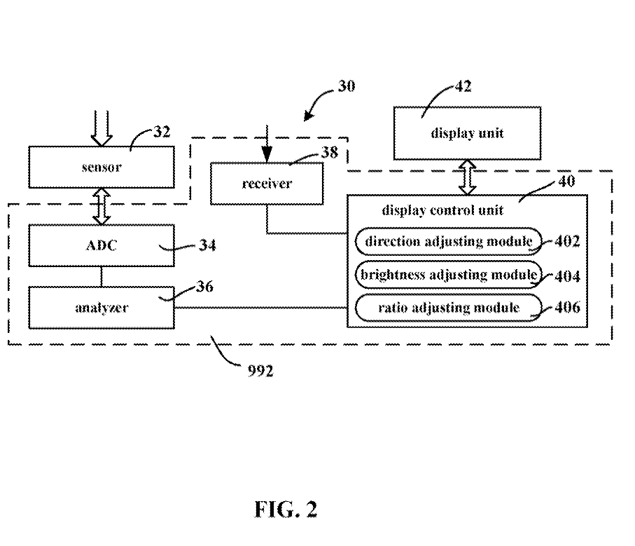

Also referring to FIG. 2, a control system 30 is used for sensing rotation, processing signal, and controlling displaying operation of the LCD 20. The control system 30 includes the sensor 32, an Analog-to-Digital Converter (ADC) 34, an analyzer 36, a receiver 38, a display control unit 40, and a display unit 42 included in the display panel 22. The ADC 34, the analyzer 36, the receiver 38, and the display control unit 40 can be considered to be a processing element 992. The processing element 992 is located in the computer 70. In the embodiment, the processing element 992 receives information from the sensor 32 and transmits information to the display unit 42 by wireless.

The sensor 32 is used for sensing a rotation of the display panel 22, and sending a signal to the ADC 34. The signal is in analog electrical form and includes rotation direction information and rotation angle information. The ADC 34 is used for converting the analog signal to digital data, and sending the digital data to the analyzer 36. The analyzer 36 is used for processing the digital data to read the rotation direction information and the rotation angle information, and sending the rotation direction information and the rotation angle information to the display control unit 40. The receiver 38 is used for receiving image data from another part (not shown) of the computer 70, and sending the image data to the display control unit 40. The display control unit 40 is used for processing the image data based on the rotation direction information and the rotation angle information. The display unit 42 is used for displaying data image according to the image data.

The display control unit 40 includes a direction adjusting module 402, a brightness adjusting module 404, and a ratio adjusting module 406. The direction adjusting module 402 is used for adjusting displaying orientation of the image data based on the rotation direction information. The brightness adjusting module 404 is used for adjusting a brightness of the image data based on the rotation direction information. When the LCD is used to display movies, the data images are adjusted to a higher level, and when the display is used for non-movie related functions such as computer monitor, the data images are adjusted to a lower level. The ratio adjusting module 406 is used for adjusting displaying ratio of the image data based on the rotation direction information and the rotation angle information.

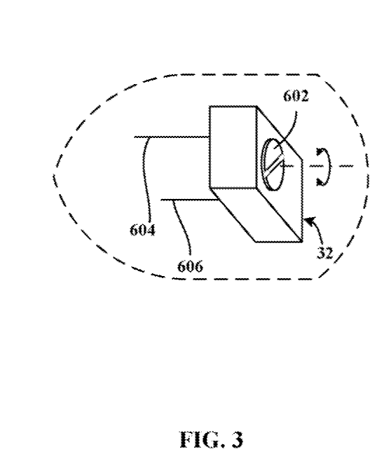

Further referring to FIG. 3, the sensor 32 is an adjustable resistor in the first embodiment. The sensor 32 includes a rotatable portion 602 for being engaged with the adjustable portion 28, and two leads 604, 606. A resistance between the leads 604 and 606 can be adjusted by rotating the rotatable portion 602. Therefore, the rotation direction information and the rotation angle information of the display panel 22 can be determined by detecting the resistance. For instance, if a value of the resistance gets greater, the display panel 22 may be rotated along with a clockwise direction, and if the value of the resistance gets smaller, the display panel 22 may be rotated along with an anticlockwise direction. When the display panel 22 is rotated, the adjustable portion 28 is also rotated with the display panel 22. The rotatable portion 602 is rotated by the adjustable portion 28, and the resistance is adjusted.

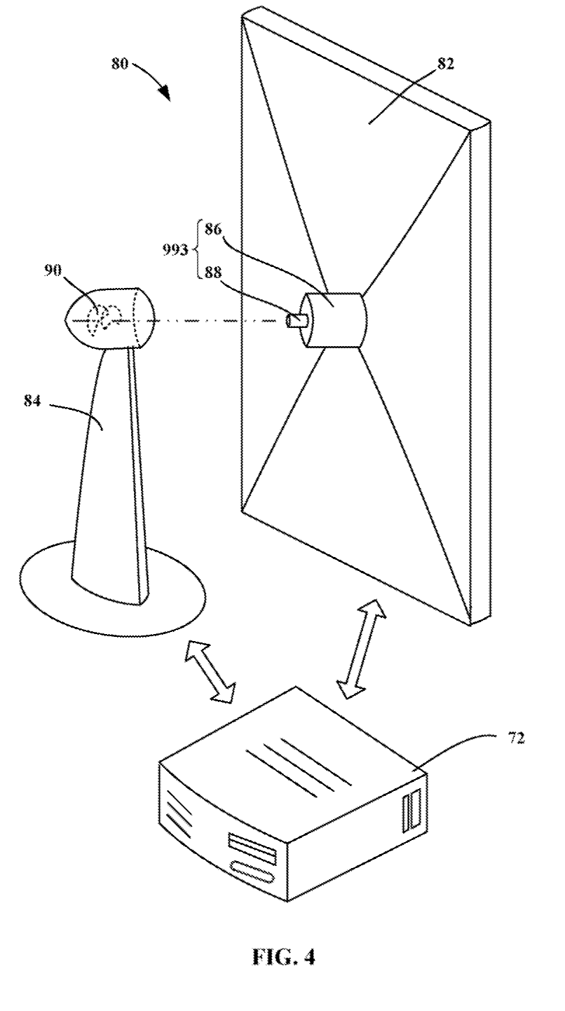

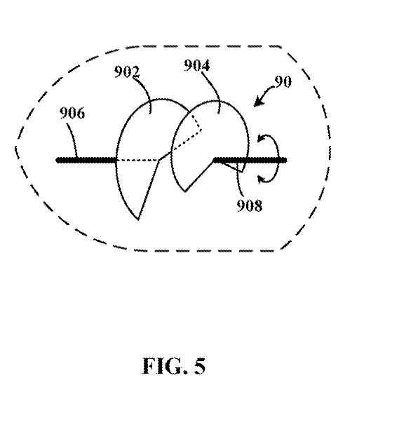

Referring to FIGS. 4 and 5, an LCD 80 in accordance with a second exemplary embodiment includes a display panel 82, a stand 84, a connection portion 86, an adjustable portion 88, and a sensor 90. The display panel 22 and the stand 24 communicate with the computer 70 by wireless. In the second embodiment, the sensor 90 is an adjustable capacitor. The sensor 90 includes two parallel fan-shaped metal sheets 902, 904, and two rods 906, 908. The rod 906 is formed on the metal sheet 902, and the rod 908 is formed on the metal sheet 904. The adjustable portion 88 is substantially cylindric in shape. The rod 908 is engaged in the adjustable portion 88. When the display panel 82 is rotated, the rod 908 is also rotated, and an overlapped surface area of the metal sheets 902, 904 is adjusted. Therefore, the capacitance of the adjustable capacitor is also adjusted. In another embodiment, the sensor 90 can be other adjustable electrical elements, such as adjustable inductors. The connection portion 86 and the adjustable portion 88 can be considered to be an adjusting element 993.

As mentioned above, adjustable electrical elements are used to sense rotation of the display panel in the LCD, and the display control unit is used to control displaying orientation, brightness, and displaying ratio of data image displayed in the display unit. Therefore, when the display panel of the LCD is rotated, data images are adjusted automatically and simultaneously.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A liquid crystal display apparatus comprising:
a rotatable display panel comprising a display unit for displaying data images;
a sensor for sensing a rotation of the display panel, and generating an analog signal containing rotation direction information and rotation angle information; and
a display control unit for adjusting displaying orientation, brightness, and display ratio of the data images based on the rotation direction information and the rotation angle information.

2. The liquid crystal display apparatus according to claim 1, wherein the sensor is an adjustable resistor comprising a rotatable portion and two leads, and a resistance between the leads can be adjusted by rotating the rotatable portion.

3. The liquid crystal display apparatus according to claim 1, wherein the sensor is an adjustable capacitor comprising two parallel fan-shaped metal sheets and two rods formed on the metal sheets respectively, and a capacitance of the adjustable capacitor can be adjusted by rotating the rods.

4. The liquid crystal display apparatus according to claim 1, further comprising a receiver for receiving image data and sending the image data to the display control unit.

5. The liquid crystal display apparatus according to claim 4, wherein the display control unit comprises a direction adjusting module for adjusting displaying orientation of the data images based on the rotation direction information.

6. The liquid crystal display apparatus according to claim 4, wherein the display control unit comprises a brightness adjusting module for adjusting a brightness of the image data based on the rotation direction information.

7. The liquid crystal display apparatus according to claim 4, wherein the display control unit comprises a ratio adjusting module for adjusting displaying ratio of the image data based on the rotation direction information and the rotation angle information.

8. The liquid crystal display apparatus according to claim 1, further comprising an Analog-to-Digital Converter for converting the analog signal to digital data.

9. The liquid crystal display apparatus according to claim 8, further comprising an analyzer for processing the digital data to read the rotation direction information and the rotation angle information, and sending the rotation direction information and the rotation angle information to the display control unit.

10. A liquid crystal display apparatus comprising:
a display panel for displaying data image;
a stand for supporting the display panel;
an adjusting element formed on the display panel and connected to stand, and the adjusting element being rotatable with respect to the stand;
a sensor set on a conjunction part of the stand and the adjusting element to sense rotation of the adjusting element, and generate an analog signal containing rotation direction information and rotation angle information; and
a processing element for processing the analog signal and adjusting the data image.

11. The liquid crystal display apparatus according to claim 10, wherein the sensor is an adjustable resistor comprising a rotatable portion and two leads, and a resistance between the leads can be adjusted by rotating the rotatable portion.

12. The liquid crystal display apparatus according to claim 10, wherein the sensor is an adjustable capacitor comprising two parallel fan-shaped metal sheets and two rods formed on the metal sheets respectively, and a capacitance of the adjustable capacitor can be adjusted by rotating the rods.

13. The liquid crystal display apparatus according to claim 10, wherein the adjusting element comprises a connection portion formed on a centre of the display panel, and an adjustable portion formed on the connection portion and engaged with the sensor.

14. The liquid crystal display apparatus according to claim 10, wherein the processing element comprises a receiver for receiving image data.

15. The liquid crystal display apparatus according to claim 14, wherein the processing element comprises a display control unit for adjusting the image data based on the rotation direction information and the rotation angle information.

16. The liquid crystal display apparatus according to claim 15, wherein the processing element comprises an Analog-to-Digital Converter for converting the analog signal to digital data.

17. The liquid crystal display apparatus according to claim 16, wherein the processing element comprises an analyzer for processing the digital data to read the rotation direction information and the rotation angle information, and sending the rotation direction information and the rotation angle information to the display control unit.
